(19) United States
(12) Patent Application Publication
(10) Pub. No.: US 2009/0089189 A1
(43) Pub. Date: Apr. 2, 2009

(54) METHODS AND SYSTEMS FOR MANAGING SURPLUS ASSETS

(75) Inventors: Paskel J. Berry, Wadsworth, OH (US); Patricia A. Lins, Bow, NH (US); John H. Birdwell, Jr., Granbury, TX (US); David W. Coger, Tallmadge, OH (US)

Correspondence Address: BUCHANAN, INGERSOLL & ROONEY PC, POST OFFICE BOX 1404, ALEXANDRIA, VA, 22313-1404, US

(73) Assignee: LOCKHEED MARTIN CORPORATION, Bethesda, MD (US)

(21) Appl. No.: 11/866,169

(22) Filed: Oct. 2, 2007

(51) Int. Cl. G06Q 40/00; G06F 17/10; G06F 17/30; G06F 17/40; G06Q 10/00

(52) U.S. Cl. 705/30

(57) ABSTRACT

Systems and methods are disclosed for managing assets in an entity having sub-entities, in which a sub-entity acquires or produces assets. The systems and methods include identifying an asset of the sub-entity to be a surplus asset, determining an offset value receivable for transfer of the asset to a client, and providing the asset to the client in exchange for an offset credit.

### FIELD

The present disclosure relates generally to management of surplus assets.

### BACKGROUND

Several patent publications are directed to the managing of assets. These include U.S. Pat. No. 6,996,538 to Lucas which discloses a system and method for allowing third-parties to monitor a company's inventory via a network and automatically order needed items. The Lucas patent discloses a forum through which resellers and customers can directly interact to resell surplus equipment.

Unite States Patent Application 2004/0138969 to Goldsmith et al. discloses a computer-automated method for decision support related to dispositioning of resources. The method includes a comparison of projected outcomes for different dispositions. For example, the comparison can lead to a decision to donate inventory to obtain a tax deduction that may yield higher earnings than realizable with other dispositions. The Goldsmith et al. application also discloses a decision support process for an enterprise management system that provides alerting, estimating, and dispositioning services related to dispositioning goods from inventory.

United States Patent Application 2004/0215544 to Vincent et al. discloses a system to account for assets after disposal. The system creates a listing of assets and this list is made available to employees who can transfer assets to other employees.

### SUMMARY

In one exemplary embodiment, a method is disclosed for managing assets in an entity having plural sub-entities, wherein a first of the plural sub-entities acquires or produces assets. The method includes identifying an asset of the first sub-entity to be a surplus asset, determining an offset value receivable for transfer of the asset to a client, and providing the asset to the client in exchange for an offset credit.

In another exemplary embodiment, a computer-readable medium is disclosed for storing instructions that, when executed by a processor, perform a method of managing assets in an entity having plural sub-entities, wherein a first of the plural sub-entities acquires or produces assets. The method includes identifying an asset of the first sub-entity to be a surplus asset, determining an offset value receivable for transfer of the asset to a client, and providing the asset to the client in exchange for an offset credit.

In another exemplary embodiment, a system is disclosed for managing assets in an entity having plural sub-entities, wherein a first of the plural sub-entities acquires or produces assets. The system includes a data processing device and a data storage device for storing a database of surplus assets. When instructions stored on a computer-readable medium are executed by the data processing device, the system identifies an asset of the first sub-entity to be a surplus asset, determines an offset value receivable for transfer of the asset to a client, and provides the asset to the client in exchange for an offset credit.

### BRIEF DESCRIPTION OF THE DRAWINGS

FIG. 1 is a block diagram illustrating an exemplary system environment as disclosed herein;

FIG. 2 is a block diagram illustrating an exemplary system as disclosed herein; and

FIG. 3 is a flow chart illustrating an exemplary method as disclosed herein.

### DETAILED DESCRIPTION

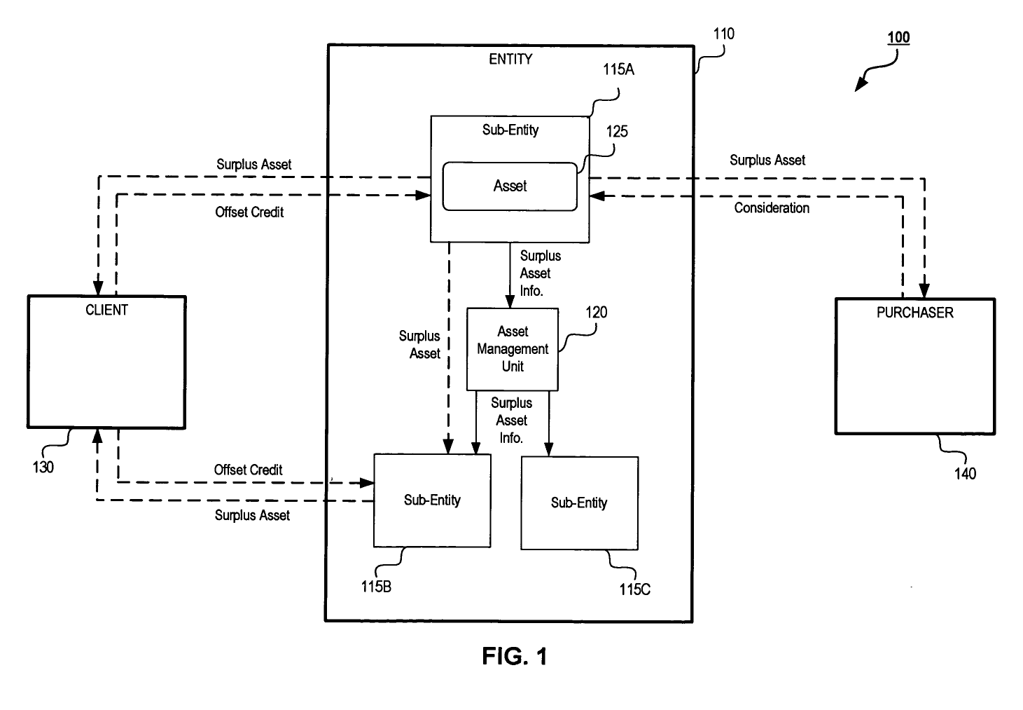

FIG. 1 is a block diagram illustrating an exemplary system environment 100 that includes an entity 110 having a plurality of sub-entities 115A, 115B & 115C (collectively referred to herein as “sub-entities 115”). Exemplary embodiments manage assets in an entity, such as entity 110, having plural sub-entities (e.g., sub-entities 115A-115C). A first of the sub-entities (e.g., sub-entity 115A) can acquire or produce assets for use within the first sub-entity. The exemplary embodiments include identifying an asset (e.g., asset 125) of the first sub-entity to be a surplus asset, determining an offset credit receivable for transfer of the asset to a client; and providing the asset to the client (e.g., client 130) in exchange for the offset credit.

Exemplary entity 110 can be a business entity, such as a corporation, and exemplary sub-entities 115 can be subsidiaries of the entity 110, which themselves can be business entities or other subunits of entity 110. Although part of entity 110, sub-entities 115 can be operated substantially independent from one another and maintain independent management, accounting, purchasing, inventory, assets, etc.

FIG. 1 shows, sub-entity 115A having an exemplary asset 125. An asset is any item, tangible or otherwise, owned by entity 110 and/or one of sub-entities 115. Asset 125 can be a capital asset that has been held for a period of time (e.g., actually held in on-site physical storage or retained on the books of the sub-entity as an asset), an asset acquired or produced by sub-entity 115A for use within the sub-entity, and/or an asset that is bought or sold in the regular course of business. For example, an asset can include buildings, machinery, or other such assets that generally cannot be turned into cash quickly.

Asset 125 is considered surplus when entity 110 or a sub-entity 115 identifies it as unneeded, undesired, or inappropriate to retain for any reason. For example, asset 125 may be parts or materials owned by entity 100 for which there is no current demand by entity 100 or sub-entity 115A, the current demand is insufficient to consume the entire amount of the asset, and/or there is no likelihood of future use by sub-entity 115A. Asset 125 can also be considered surplus when its value is such that disposing of the asset could be financially advantageous.

FIG. 1 additionally shows entity 110 having an exemplary asset management unit 120. Asset management unit 120 can include individuals and/or systems for managing, coordinating, acquiring, maintaining, and/or disposing of assets for entity 110 and sub-entities 115. Asset management unit 120 can coordinate transfers and disposals of surplus assets. For example, when entity 110 or one of sub-entities 115 identifies asset 125 as surplus, asset management unit 120 can receive notification, identify other sub-entities 115 that may desire asset 125, and/or facilitate the transfer of asset 125 between sub-entities 115.

System environment 100 also includes exemplary client 130 and purchaser 140 that are potential acquirers of surplus asset 125. Client 130 can be an entity that acquires goods and/or services from entity 100 or sub-entities 115. In some embodiments, client 130 is a national government (or agent thereof) that purchases goods and/or services from entity 100 or sub-entities 115, and that requires consideration and/or inducements from entity 100 as a condition of the purchases.

Considerations and inducements required by an acquirer of asset 125, such as client 130, are referred to herein as “offset requirements.” An offset requirement can be a prerequisite, concurrent or subsequent condition required by the acquirer to an agreement or contract. An offset requirement can specify the total value of offsets that must be provided in return for client's agreement to a purchase. An “offset,” as used herein, is a good or service provided, or an activity undertaken, in satisfaction of an offset requirement. The credit granted by an acquirer in return for an offset is referred to herein as “offset credit.” The offset credit granted by an acquirer is not always equal to the monetary credit of the offset. An acquirer can, for example, grant an offset credit greater than the monetary value of particular offsets to encourage certain types highly desirable offsets (e.g., advanced technology or training) to be used in satisfaction of an offset requirement.

For instance, in the defense industry, a government that purchases goods and services from a defense supplier may make “defense offsets requirements.” Defense offset requirements (also referred to “industrial participation”) can include any industrial or commercial benefits that a defense supplier provides as an inducement or condition for the purchase of goods and services. Defense offset requirements can include co-production arrangements, subcontracts, technology transfers, in-country procurements, marketing and financial assistance, joint ventures, or the like. Defense offset requirements are of two exemplary forms—direct and indirect.

Through direct offset requirements, an acquirer of goods or services from entity 110 or a sub-entity 115, such as client 130, receives work or technology directly related to goods and/or services purchased. Indirect offset requirements can involve barter and counter-trade deals, investment in the buying country, or the transfer of technology unrelated to the goods and/or services being purchased. For example, if asset 125 is a vehicle that is provided to client 130 to satisfy a condition of a contract for sale of an unrelated missile systems by sub-entity 115 to client 130, then asset 125 can be considered an offset that satisfies an indirect offset requirement. In such cases, asset 125 my be referred to as an “indirect offset.”

Purchaser 140 can be an individual or entity that acquires surplus asset 125 from entity 100 or sub-entity 115 by sale or gift, but not as an offset. In return for providing surplus asset 110 to purchaser 140, entity 100 can receive consideration, such as cash, tax credits or some other value. Purchaser 140 may acquire surplus asset 125 in various manners. For example, purchaser 140 can be selected from a buyer's list to purchase the asset, purchase surplus asset 125 from sub-entity 115A as scrap, or receive surplus asset 125 in donation as a charitable entity (e.g., a school, charity, or the like).

In an example consistent with the exemplary embodiment shown in FIG. 1, entity 100 can be a corporation that provides goods and services to the U.S. military and/or the militaries of other nations. Entity 100 can be made up of a number of sub-entities 115 that constitute substantially independent business units. Because sub-entities 115 are essentially independent from one another, sub-entity 115B may be unaware of asset 125 owned by sub-entity 115A. As such, sub-entity 115B may have a desire or need for asset 125 but sub-entity 115A will not be aware of sub-entity 115B's needs. As a result, even if 115A does not have any use for asset 125, sub-entity 115A may retain asset 125 or dispose of it to the detriment of entity 110 on the whole.

Alternatively, asset 125 may be identified as surplus to asset management unit 120, for example. Entity 110 can request that sub-entities 115 periodically review of all their respective assets on a periodic basis to determine if they own any surplus. In other cases, sub-entities 115 or asset management unit 120 can generate usage reports for capital assets to identify any surplus.

Once asset 125 is identified by sub-entity 115A as surplus, asset management unit 120 can determine whether any other of sub-entities 115 needs or desires asset 125. In some instances, sub-entities 115 can periodically produce capital purchase plans that identify capital assets the entities plan to purchase in the future. Asset management unit 120 can review the asset purchase plans to determine whether surplus asset 125 of sub-entity 115A can satisfy a future purchase another one of sub-entities 115. If so, asset management unit 120 can recommend that sub-entity 115A transfer surplus asset 125.

In other instances, asset management unit can advertise the availability of surplus asset 125 to sub-entities 115. For example, asset management unit 120 can publish a list and transmit the list via, for example, electronic mail to sub-entities 115 announce surplus asset's 125 availability. The announcement can include a description of the asset, and/or providing a network link to more complete information.

Asset management unit 120 can coordinate the transfer of asset 125 and ensure that it is properly accounted for by entity 110 and sub-entities 115. For instance, based on capital purchase plans submitted by a sub-entity 115B, asset management unit 120 may recommend surplus asset 125 to sub-entity 115B to maximize value of asset 125 to entity 100 and save sub-entity the expense of purchasing the same asset.

Once asset 125 is identified as surplus, entity 110 can provide a transfer incentive to sub-entity 115A to encourage the transfer of asset 125. If, for instance, asset 125 has a value is greater than some threshold value (e.g., ten-thousand dollars), entity 110 can provide a transfer incentive to sub-entity 115A if surplus asset 125 is transferred to another one of sub-entities 115. The transfer incentive can be a percentage of the original purchase price. For accounting purposes, the value of the transfer incentive can be provided (i.e., debited) to sub-entity 115A and be charged (i.e., credited) to entity 110. In this manner, entity 110 may motivate the efficient use of asset 125.

In instances where none of sub-entities 115 desire or need surplus asset 125, the asset can be considered for use in satisfying offset requirements of entity 110 or a sub-entity 115. In other words, where entity 110 has no internal need for asset 125, the asset's value to entity 110 can be maximized by transferring the asset to client 130 in return for offset credit rather than disposing of the asset.

In other instances, sub-entity 115B may desire asset 125 from sub-entity 115A for its own use as an offset. Where asset 125 has a value greater than the transfer incentive value, allocation of asset 125 to sub-entity 115B can result in an exchange in which sub-entity 115A receives an incentive value from entity 110 and sub-entity 115B receives the offset credit from client 130.

Upon asset 125 being allocated to sub-entity 115B or client 130, asset management unit 120 removes asset 125 from surplus asset database 226. If asset 125 is not allocated within entity 110 as an offset, then asset 125 can be disposed of (e.g., sold or donated) with an acquirer, such as purchaser 140. In some cases, asset 125 is disposed of after a predetermined period of time (e.g., thirty days) if not transferred or designated for use as an offset.

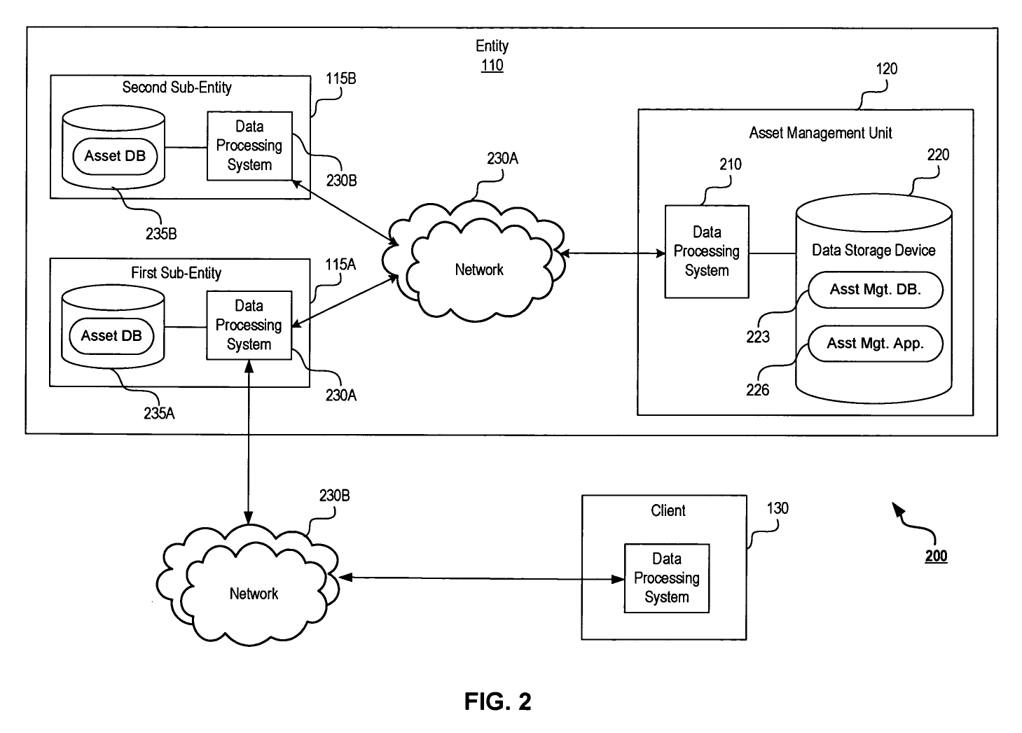

FIG. 2 is a block diagram illustrating an exemplary system 200 for managing assets in an entity, such as entity 100, having plural sub-entities, such as sub-entities 115A & B. A first of the sub-entities 115 can acquire or produce assets for use within the first sub-entity. The exemplary system can include a data processing device, such as data processing system 210, and one or more data storage devices, such as data storage device 220, for storing a database of surplus assets. The one or more data storage devices can store instructions that, when executed by a data processing device, can perform a method that includes identifying an asset of the first sub-entity to be a surplus asset, determining an offset credit receivable for transfer of the asset to a client, and providing the asset to the client in exchange for the offset credit.

Asset management unit 120 can include a data processing system 210 and a data storage device 220 storing a database 226 of surplus assets, including asset 125. Data processing system 210 can be implemented as one or more computer systems including, for example, a personal computer, minicomputer, microprocessor, workstation, mainframe, or any similar known computing platform employed in the art. Additionally, data processing system 210 can have components of such computing systems including, for example, a processor, memory, and data storage devices.

Data storage device 220 can store instructions that, when executed by the data processing system 210, perform a method of managing assets in an entity having plural sub-entities. Data storage device 220 can be implemented with a variety of components or subsystems including, for example, a magnetic disk drive, an optical disk drive, flash memory, or other devices capable of storing information. Further, although data storage device 220 is shown as part of system 200, it can be located partially or completely externally. For instance, data storage device 220 can be configured as network accessible storage located remotely from data processing system 210. Although data processing system 210 and data storage device 220 are shown as being within asset management unit 120, the location is merely exemplary. Data processing system 210 and data storage device 220 can be physically located inside and/or outside of entity 110.

Network 230A is a communications network by which individuals of entity 110 or sub-entities 115 can communicate with data processing system 210 of asset management unit 120. Network 230B is a commutation network by which individuals or sub-entities 115 can communicate with, for example, client 130 and/or purchaser 140. Networks 230A & B can be shared, public, private, or peer-to-peer networks, encompassing any wide or local area network, such as an extranet, an intranet, the Internet, a Local Area Network (LAN), Wide Area Networks (WAN), public switched telephone networks (PSTN), Integrated Services Digital Networks (ISDN), or any other form of wired or wireless communication networks. Further, networks 230A & B may be compatible with any type of communications protocol used by the components of system environment 100 to exchange data, such as the Ethernet protocol, ATM protocol, Transmission Control/Internet Protocol (TCP/IP), Hypertext Transfer Protocol (HTTP), Hypertext Transfer Protocol Secure (HTTPS), or peer-to-peer protocols. The particular composition and protocol of networks 230A & B is not critical as long as it allows for communication between data processing system 210, sub-entities 115, client 130 and/or purchaser 140.

As further shown in FIG. 2, data storage device 220 can store asset management application 223 and surplus asset database 226. Asset management application 226 can be retrieved by data processing system 210 from data storage device 225. By executing asset management application 223, data processing system 210 can provide an interactive user interface for submitting and/or retrieving information requests submitted from asset management unit 120 and sub-entities 115 from surplus asset database 226.

Asset management unit 120 can manage asset management application 223 and surplus asset database 226. Asset management application 223 is one or more software modules executable to manage assets. For instance, asset management application 223 can be part of an enterprise management system which can be a software application for tracking, managing, and/or controlling the operations of entity 110 and/or sub-entities 115. Asset management application 223 can provide an interactive graphic user interface accessible by employees of entity 100 and sub-entities 115 to retrieve and view information describing assets stored in surplus asset database 226. Surplus asset database 226 can be a searchable, relational database that stores information describing assets, such as descriptions, images, specifications, data sheets, financial and accounting data, etc.

For instance, asset management application 226 can provide a list of surplus asset 125 on a web site accessible over an intranet of entity 110. Via the web site, sub-entities 115 can browse listings of all identify surplus assets available within entity 110. The listing can include, descriptions (e.g., age, date of purchase, value), specifications, photos, videos, values and contact information for the listed assets. Accordingly, using the web site, sub-entity 115B can retrieve information describing surplus asset 125 and request transfer of the asset from sub-entity 115A.

Sub-entities 115 can include a data processing systems and a data storage devices storing a database of assets; for example data processing systems 230A & B, and data storage devices 235A & B. As above, data processing systems 230 can be implemented as one or more computer systems including, for example, a personal computer, minicomputer, microprocessor, workstation, mainframe, or any similar known computing platform employed in the art. Additionally, data processing systems 230 can have components of such computing systems including, for example, a processor, memory, and data storage devices. Data storage devices 235 can be implemented with a variety of components or subsystems including, for example, a magnetic disk drive, an optical disk drive, flash memory, or other devices capable of storing information.

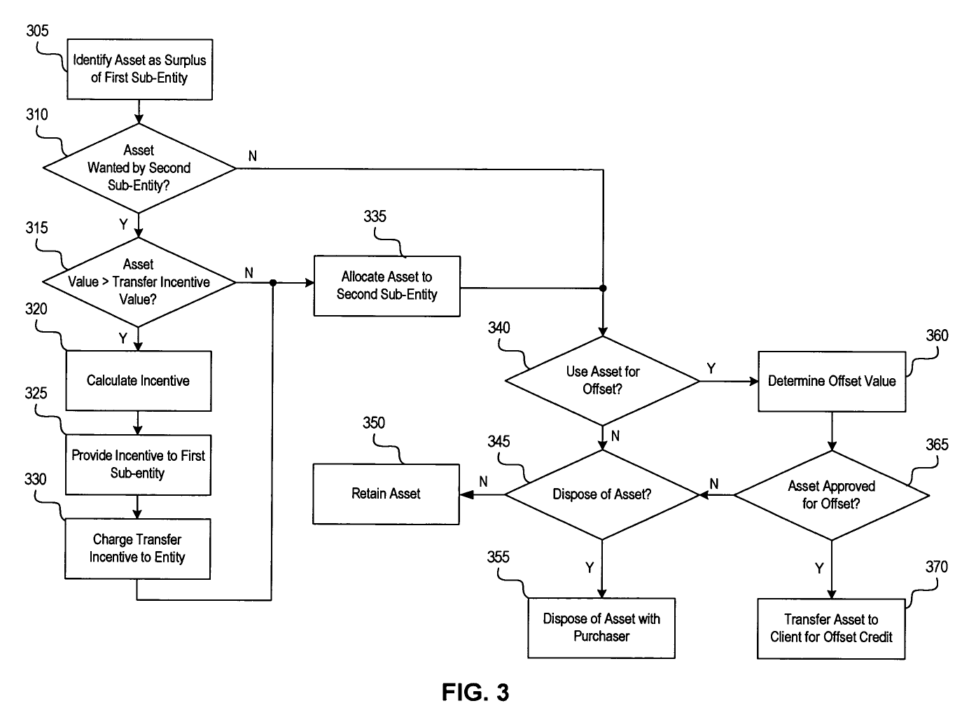

FIG. 3 is a flowchart illustrating an exemplary method of managing assets in an entity, such as entity 100, having plural sub-entities, such as sub-entities 115A-C, wherein a first sub-entity, such as sub-entity 115A, acquires or produces assets, such as asset 125, for use within the first sub-entity. The exemplary method includes identifying an asset of the first sub-entity to be a surplus asset, determining an offset value receivable for transfer of the asset to a client; and providing the asset to the client in exchange for an offset credit.

At the outset, asset 125 of sub-entity 115A is identified as being a surplus asset. (Step 305.) The identification can be made by entity 110, sub-entity 115A or asset management unit 120, for example, as part of a periodic inventory or survey. Data identifying asset 125 as being surplus can be added or updated in surplus asset database 226 by asset management unit 120 or sub-entities 115. Surplus asset database 226 can be updated by asset management unit 120 or sub-entities 115.

The exemplary method determines whether asset 125 is desired by another one of sub-entities 115. (Step 310.) For instance, sub-entity 115B can review a list of available surplus assets generated by asset management application 223 from surplus asset database 226. The list of surplus assets can be published by asset management unit 120 and distributed to sub-entities 115, or sub-entities 115 can retrieve the list from data processing system 210 over communications network 230. Data processing system 210 can provide an interactive Web page that can be searched and browsed by sub-entities 115 via remote terminals, for instance.

In other instances, the determination of whether surplus asset 125 is desired by a sub-entity 115B can be based on a purchase plan of sub-entity 115B. For example, asset management unit 120 can review capital purchase plans submitted by sub-entities 115 and, based on the review, recommend surplus asset 125 to any of sub-entities 115 that plan to purchase the same or similar asset 125 that is surplus in another sub-entity. By making surplus asset 125 known and available to other sub-entities 115, asset management unit 120 is able to maximize the value of the asset 125 within entity 110.

If it is determined that asset 125 is desired by at least one sub-entity 115 (step 310, yes), it can be determined whether the value of asset 125 is greater than a transfer incentive value (step 315). If the value of asset 125 is greater than the transfer incentive value (step 315, yes), an incentive amount is assessed (e.g., calculated) (step 320). The incentive amount can be based on the value of asset 125. For example, the incentive amount can be a percentage of asset 125's original purchase value. The incentive amount, however, is not limited to this method and the amount can be assessed in any manner (e.g., percentage of value, flat rate, progressive rate, etc.).

Along with allocating asset 125 to sub-entity 115B (step 335), the incentive value is provided to sub-entity 115A as an incentive for transferring asset 125 (step 325) and the incentive value is charged to entity 110 (step 330). In other words, the incentive is provided by entity 110 to sub-entity 115A for the benefit of sub-entity 115B. Entity 110 also benefits since sub-entity 115B did not purchase a duplicate of asset 125 which was already owned by entity 125, but held by sub-entity 115A. Otherwise, if the value of asset 125 is determined to be less than the incentive amount, asset 125 is allocated to sub-entity 115A to 115B (step 335) without providing sub-entity 115A any incentive amount.

If it is determined that asset 125 is not desired by at least one sub-entity 115 (step 310, no), it can be determined whether asset 125 can be used as an offset. (Step 340.) Alternatively, the determination of whether asset 125 can be used as an offset may occur where sub-entity desires asset 125. For example, where entity 110 is a defense supplier, asset 125 can qualify as an indirect offset if the asset can be used to fulfill an offset requirement associated with defense equipment being sold under a contract with client 130. Moreover, in some exemplary instances, sub-entity 115B may desire asset 125 for use an offset. Accordingly, sub-entity 115B can request that sub-entity 115A transfer asset 125. If asset 125 has a value greater than the transfer incentive value, sub-entity 125 can receive a transfer incentive from entity 110, and sub-entity 115 may receive an offset credit from client 130. Thus, more efficient use of asset 125 can be realized in embodiments disclosed herein.

If it is determined that asset 125 can be used as an offset (step 340, yes.), an offset value receivable for transfer of asset 125 to client 130 is determined (step 360). The offset value can be determined based on an offset credit receivable from client 130, as well as a cost of not using the asset as an offset, a cost of disposing of the asset. The offset value can be based on several other factors, including: a current value of the asset, a cost of relocating the asset, a cost of installing the asset at the purchaser's location, and/or a cost of training use of the asset. For instance, an offset cost profile can be created for asset 125. If a ratio between the offset value determined in the cost profile to the value of asset 125 is greater than a threshold, then asset 125 can be approved for use as an offset.

Based on the determined offset value for asset 125, it can be decided whether to approve asset 125 for use as an offset. (Step 365.) The decision can also be based on other financial, political, strategic, and security considerations. In some cases, it can be determined that the cost risk in dismantling asset 125, shipping, and reassembling asset 125 is too great to justify a determination to use the asset as an offset. In other cases, where use of asset 125 as an offset may be financially beneficial, the transfer of asset 125 to client 130 can be denied because, for example, an export license cannot be obtained for the asset. In other cases, asset 125 can be proprietary or classified material that my not be transferred due to legal and/or contractual responsibilities. Further, regardless of the approval, client 130 can reject asset 125 and, accordingly, asset 125 cannot be approved for use as an offset.

If asset 125 is approved for use as an offset, the asset is provided to client 130 in exchange for the offset credit. (Step 370.) If, however, it is determined that asset 125 is not desired by entity 110 or any of sub-entities 115, and asset 125 will not or cannot be used as an offset, it is determined whether asset 125 will be retained (step 350) or disposed of (step 355).

If it is decided to dispose of asset 125 (step 345, yes), asset can be disposed of using any method (step 355). It may be determined to dispose of asset 125 based on a determination of a cost of not using the asset as an offset and/or a determination of a cost of disposing of the asset. Disposing of asset 125 can include the sale, scrap, or donation of asset 125. Sale or scrap of asset 125 can include transferring the asset in return for payment. For instance, asset 125 may be sold to a scrap dealer. Donating asset 125 can include giving the asset to a purchaser 140 such as a school, charity or mentor/protege organization. Entity 110 and/or sub-entity 115A may receive a tax credit based on the value of asset 125. Once asset 125 is disposed of, sub-entity's 115A inventory and surplus asset database 223 can be updated to remove asset 125. Otherwise, if asset is not disposed of (step 345, no), then the asset is retained by the sub-entity to which it is allocated (step 350).

The following provides exemplary pseudo-code that can be use in a method of dynamically managing a database of assets in a network of entity 110's (such as a corporate network) having first sub-entity 115A that maintains a first database of assets, including a record of a surplus asset 125, at least a second sub-entity 115B that maintains a respective second database of assets, and asset management unit 120 that maintains a respective third database of surplus asset information:
/receive a message including information describing the surplus asset of the first sub-entity from the first sub-entity data processing system at the asset management unit data processing system/
/store by the asset management unit data processing system the information describing the surplus asset in at least one record in the surplus asset database/
/issue by the asset management unit data processing system a notification of the surplus asset to other sub-entities, including the second sub-entity data processing system/
/if a request for the surplus asset is received by the asset management unit data processing system from the second sub-entity data processing system, then
issue a notification from the asset management unit data processing system to the first sub-entity data processing system to transfer the record from the first database to the second sub-entity data processing system;
issue a notification from the asset management unit data processing system to an accounting data processing system to record the transfer of the surplus asset from the first sub-entity to the second sub-entity;
remove surplus asset record from surplus asset database by the asset management unit data processing system;
remove the surplus asset record from first database by the first sub-entity data processing system;
add the surplus asset record to the second database by the second sub-entity data processing system;
end/
/else if no request is received from one of the other sub-entities within a predetermined time, then issue a notification by the asset management unit data processing system to the first sub-entity data processing system indicating disposal of the surplus asset/
   /if surplus asset is to be used as an offset, issue from the first sub-entity data processing system to a client data processing system over a second network, a message proposing use of the surplus asset as an offset and including information describing the surplus asset;
   receive a response from client data processing system by the first sub-entity data processing system;
   /if proposed offset credit is accepted by the client, then issue message from first sub-entity data processing system to the asset management unit data processing system to remove the surplus asset record from the surplus asset database;
   end/
   /else if the surplus asset is disposed of by first sub-entity, then
   remove the surplus asset record from first database by first sub-entity data processing system; and
   issue a notification from first sub-entity data processing system to the accounting data processing system to record disposal of the surplus asset; and
   remove the surplus asset record from first database by first sub-entity data processing system;
   end/

As disclosed herein, embodiments and features can be implemented through computer hardware and/or software. Such embodiments can be implemented in various environments, such as networked and computing-based environments with one or more users. The present invention, however, is not limited to such examples, and embodiments can be implemented with other platforms and in other environments.

Moreover, while illustrative embodiments have been described herein, further embodiments can include equivalent elements, modifications, omissions, combinations (e.g., of aspects across various embodiments), adaptations and/or alterations as would be appreciated by those in the art based on the present disclosure.

Other embodiments of the invention will be apparent to those skilled in the art from consideration of the specification and practice of the embodiments of the invention disclosed herein. Further, the steps of the disclosed methods can be modified in any manner, including by reordering steps and/or inserting or deleting steps, without departing from the principles of the invention. It is therefore intended that the specification and embodiments be considered as exemplary only.

What is claimed is:

1. A method of managing assets in an entity having plural sub-entities, wherein a first of the plural sub-entities acquires or produces assets, the method comprising:
identifying an asset of the first sub-entity to be a surplus asset;
determining an offset value receivable for transfer of the asset to a client; and
providing the asset to the client in exchange for an offset credit.

2. The method of claim 1, wherein the value of the offset is based on one more of the following: the offset credit, a current value of the asset, a cost of relocating the asset, a cost of installing the asset location; and a cost of training use of the asset.

3. The method of claim 1, wherein providing the asset includes:
allocating the asset to a second of the plural sub-entities in exchange for an incentive value from the entity and the offset credit from the client by the second sub-entity.

4. The method of claim 3, wherein allocating the asset includes:
determining that the current value of the asset is greater than a threshold value.

5. The method of claim 1, wherein determining an offset credit includes:
determining a cost of not using the asset as an offset; and
determining a cost of disposing of the asset.

6. The method of claim 5, wherein, based on the determining of the offset credit, it is determined to dispose of the asset.

7. The method of claim 1, wherein the incentive value is debited to the first sub-entity, and credited to the entity.

8. The method of claim 7, comprising:
evaluating whether the asset is to be transferred to the second sub-entity or whether the asset is to be provided to a client, wherein evaluating includes:
determining that the asset is not requested by the second sub-entity; and
determining a value of the asset to the client.

9. A computer-readable medium storing instructions that, when executed by a processor, perform a method of managing assets in an entity having plural sub-entities, wherein a first of the plural sub-entities acquires or produces assets, the method comprising:
identifying an asset of the first sub-entity to be a surplus asset;
determining an offset value receivable for transfer of the asset to a client; and
providing the asset to the client in exchange for an offset credit.

10. The computer-readable medium of claim 9, wherein the value of the offset is based on one more of the following: the offset credit, a current value of the asset, a cost of relocating the asset, a cost of installing the asset location; and a cost of training use of the asset.

11. The computer-readable medium of claim 9, wherein providing the asset includes:
allocating the asset to a second of the plural sub-entities in exchange for an incentive value from the entity and the offset credit from the client by the second sub-entity.

12. The computer-readable medium of claim 11, wherein allocating the asset includes:
determining that the current value of the asset is greater than a threshold value.

13. The computer-readable medium of claim 9, wherein determining an offset credit includes:
determining a cost of not using the asset as an offset; and
determining a cost of disposing of the asset.

14. The computer-readable medium of claim 13, wherein, based on the determining of the offset credit, it is determined to dispose of the asset.

15. The computer-readable medium of claim 9, wherein the incentive value is debited to the first sub-entity, and credited to the entity.

16. The computer-readable medium of claim 15, including evaluating whether the asset is to be transferred to the second sub-entity or whether the asset is to be provided to a client, wherein evaluating includes:
determining that the asset is not requested by the second sub-entity; and
determining a value of the asset to the client.

17. A system for managing assets in an entity having plural sub-entities, wherein a first of the plural sub-entities acquires or produces assets, the system comprising:
a data processing device;
a data storage device storing a database of surplus assets; and
a computer-readable memory storing instructions that, when executed by the data processing device, perform a method of managing assets in an entity having plural sub-entities, the method comprising:
identifying an asset of the first sub-entity to be a surplus asset;
determining an offset value receivable for transfer of the asset to a client; and
providing the asset to the client in exchange for an offset credit.
